(19) United States
(12) Patent Application Publication
(10) Pub. No.: US 2014/0128114 A1
(43) Pub. Date: May 8, 2014

(54) Interactive Broadcasting Method for Broadcasting system and Related Service Providing System

(71) Applicant: Jiun Hung, Hsinchu City (TW)

(72) Inventor: Jiun Hung, Hsinchu City (TW)

(21) Appl. No.: 14/070,597

(22) Filed: Nov. 4, 2013

Related U.S. Application Data
(60) Provisional application No. 61/723,763, filed on Nov. 7, 2012.

(51) Int. Cl. H04B 7/26

(52) U.S. Cl. CPC H04B 7/26
USPC 455/500

(57) ABSTRACT

The present invention discloses an interactive broadcasting method for a broadcasting system. The interactive broadcasting method includes emitting, by a broadcasting station of the broadcasting system, radio signals carrying a broadcast program via an air interface; receiving, by a broadcast service receiving module corresponding to the broadcasting station, the broadcast program via the air interface and a command for triggering a service introduced in the broadcast program; sending, by the broadcast service receiving module, a request related to the service to a service management device via a network-based interface; providing, by the service management device, the service for the broadcast service receiving module according to the received request via the network-based interface.

### CROSS REFERENCE TO RELATED APPLICATIONS

This application claims the benefit of U.S. Provisional Application No. 61/723,763, filed on Nov. 7, 2012 and entitled “Systems and Methods for Prompt Subscription for Linearly Provided Digital Contents”, the contents of which are incorporated herein by reference.

### BACKGROUND OF THE INVENTION

1. Field of the Invention

The present invention relates to a broadcasting method and system, and more particularly, to an interactive broadcasting method for a broadcasting system and a related service providing system.

2. Description of the Prior Art

Amplitude modulation (AM) and frequency modulation (FM) are well-known audio broadcasting techniques. Both techniques transmit information in the form of electromagnetic waves. In AM, the signal or carrier is modulated in amplitude to be transmitted, while in FM, information is encoded by varying the frequency of radio waves. Traditionally, contents of the audio broadcasting are transmitted in analog form via AM and FM. In recent years, as digital audio broadcasting (DAB) technology advances, the contents of the audio broadcasting may also be transmitted in digital form, which allows the broadcasting station to include digital data or information in the transmitted signals. The radio data system (RDS) also provides a protocol for embedding small amount of digital information in conventional FM broadcasts. Both the DAB and RDS techniques allow the information other than the broadcast program content to be transmitted to the audience.

Common audio broadcasting systems are unidirectional systems, wherein the broadcasting station sends voices or sounds to the broadcast receiver through one-way transmission. In the advanced systems such as the DAB and RDS, since the carried information or data is also transmitted in a unidirectional channel, the audience may not return any feedback in response to the received information, which limits the facility of the audio broadcasting systems. For example, if an audience hears an interesting song on a broadcast program and wants to keep a record of the title or lyrics of the song or even purchase the song, the audience may need to remember parts of lyrics or melody and surf the Internet to find other information of this song. However, people always listen to the audio broadcast program during driving; hence the audience may not be able to access the Internet immediately. After a while, the audience may forget the lyrics or melody she/he has heard. Sometimes, the host of the program may introduce a free gift, and the audience should access the website of the broadcasting station or make a phone call to the broadcasting station to ask for the free gift. It is inconvenient and time consuming for the audience, especially when she/he is driving a car. Thus, there is a need for improvement over the prior art.

### SUMMARY OF THE INVENTION

It is therefore an objective of the present invention to provide an interactive broadcasting method for a broadcasting system and a related service providing system, which are capable of providing services for a user of the broadcasting system and allowing the user to request and receive services introduced in a broadcast program via a simple operation.

The present invention discloses an interactive broadcasting method for a broadcasting system. The interactive broadcasting method comprises emitting, by a broadcasting station of the broadcasting system, radio signals carrying a broadcast program via an air interface; receiving, by a broadcast service receiving module, the broadcast program via the air interface and a command for triggering a service introduced in the broadcast program; sending, by the broadcast service receiving module, a request related to the service to a service management device via a network-based interface; providing, by the service management device, the service for the broadcast service receiving module according to the received request via the network-based interface.

The present invention further discloses a service providing system. The service providing system comprises a broadcasting system, a service management device and a broadcast service receiving module. The broadcasting system comprises a broadcasting station, is utilized for emitting radio signals carrying a broadcast program via an air interface. The service management device, communicating with the broadcasting system, is utilized for managing services. The broadcast service receiving module comprises a broadcast receiver, for receiving the broadcast program via the air interface; a user interface, for receiving a command for triggering a service introduced in the broadcast program; a request sending module, for sending a request related to the service to the service management device via the network-based interface; and a user service terminal, for receiving the service provided by the service management device according to the request via the network-based interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a service providing system according to an embodiment of the present invention.

FIG. 2 is a schematic diagram of an exemplary implementation of the service management device shown in FIG. 1.

FIG. 3 is a schematic diagram of an interactive broadcasting process according to an embodiment of the present invention.

FIG. 4 is a schematic diagram of the service identifier corresponding to the service included in the broadcast program.

FIG. 5 is a schematic diagram of the time stamp and channel corresponding to the service according to an embodiment of the present invention.

FIG. 6 is a schematic diagram of selecting items displayed in the user interface according to an embodiment of the present invention.

### DETAILED DESCRIPTION

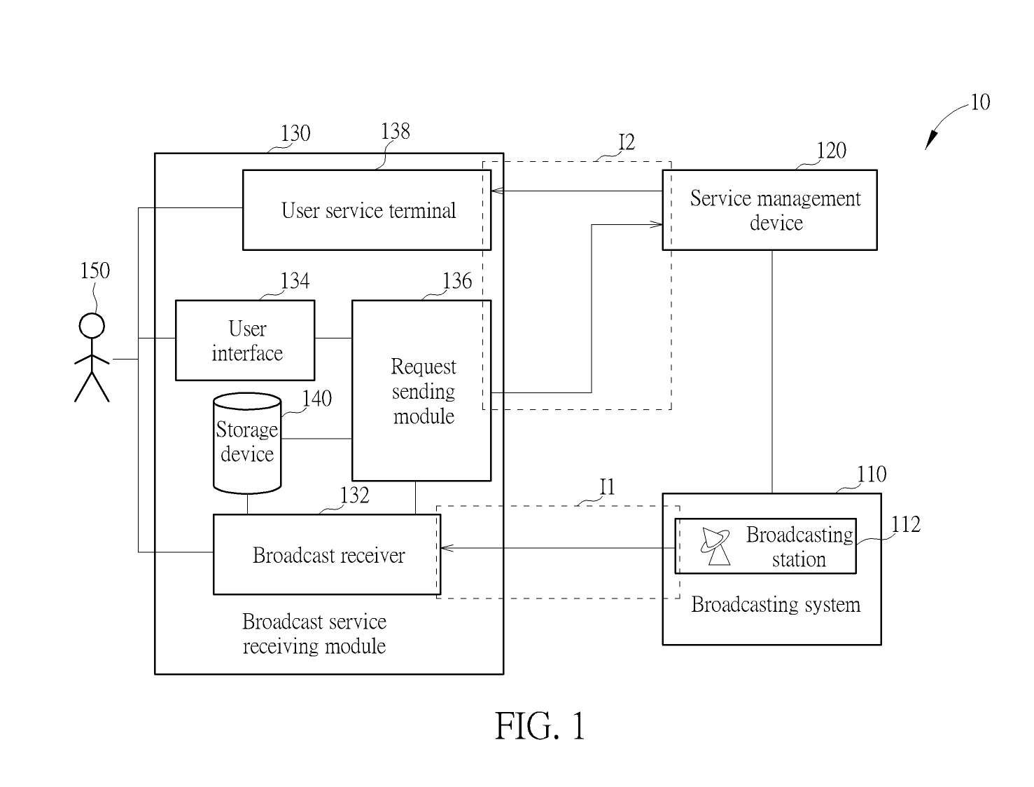

Please refer to FIG. 1, which is a schematic diagram of a service providing system 10 according to an embodiment of the present invention. As shown in FIG. 1, the service providing system 10 includes a broadcasting system 110, a service management device 120 and a broadcast service receiving module 130. The broadcasting system 110 includes a broadcasting station 112. Although a broadcasting system may possess more than one broadcasting station, only one broadcasting station is illustrated in FIG. 1 for easy reference. The broadcasting station 112 may emit radio signals carrying a broadcast program via an air interface I1. The service management device 120, communicating with the broadcasting system 110, is utilized for managing services and providing services to audiences of the broadcasting system 110. The broadcast service receiving module 130 includes a broadcast receiver 132, a user interface 134, a request sending module 136, a user service terminal 138 and a storage device 140. The broadcast receiver 132 is utilized for receiving the broadcast program from the broadcasting station 112 via the air interface I1. The user interface 134 is utilized for receiving a command from a user 150 for triggering a service introduced in the broadcast program. The request sending module 136, coupled to the user interface 134, is utilized for sending a request related to the service to the service management device 120 via the network-based interface 12. The user service terminal 138 is utilized for receiving the service provided by the service management device 120 according to the request via the network-based interface 12. The storage device 140 is utilized for storing information related to the request for the service.

In an embodiment, a service identifier (ID) corresponding to the service is included in the broadcast program; hence, the service management device 120 may generate the service ID and transmit the service ID to the broadcasting system 110. The service ID is a unique text, code or signal pattern utilized for specifying the service, wherein the service content or details of the service may not be included in the service ID.

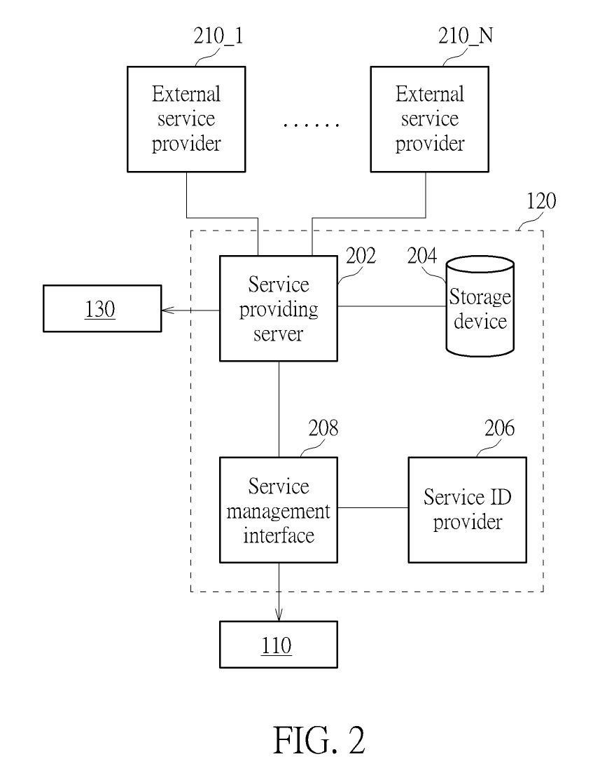

Please refer to FIG. 2, which is a schematic diagram of an exemplary implementation of the service management device 120 shown in FIG. 1. As shown in FIG. 2, the service management device 120 includes a service providing server 202, a storage device 204, a service ID provider 206 and a service management interface 208. The service providing server 202 is utilized for receiving information related to the service from external service providers 210_{—}1-210_N, and providing the service to the user service terminal 138 of the broadcast service receiving module 130 according to the request related to the service received from the request sending module 136 of the broadcast service receiving module 130. The storage device 204, coupled to the service providing server 202, is utilized for storing the information related to the service. The information related to the service may include service content and subscription/request information corresponding to the broadcast service receiving module 130. The service ID provider 206 is utilized for determining the service ID corresponding to the service. The service management interface 208, coupled to the service providing server 202 and the service ID provider 206, is utilized for transmitting the service ID to the broadcasting system 110 and communicating with the broadcasting system 110 for the information related to the service content.

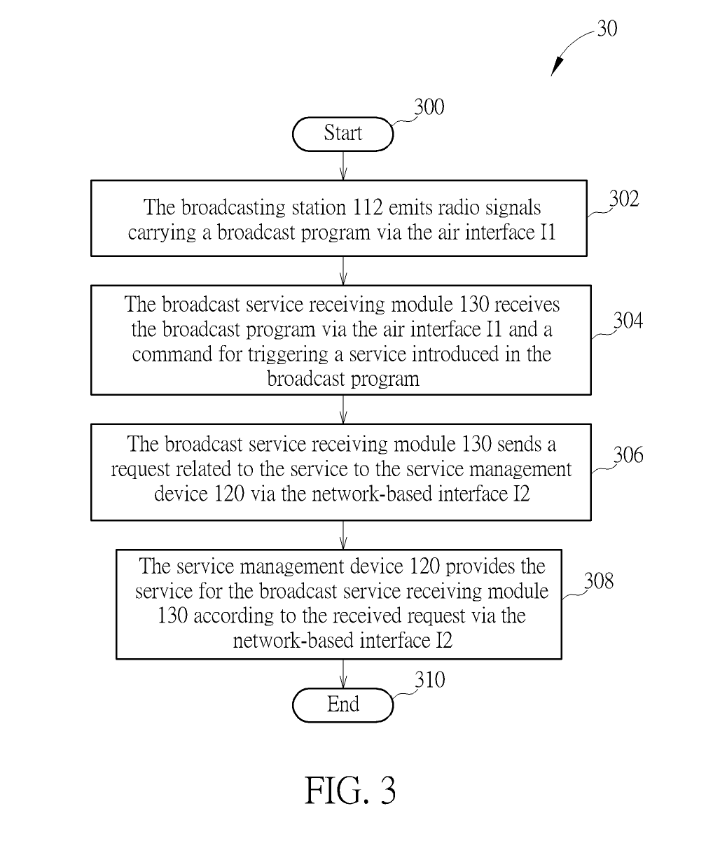

Please refer to FIG. 3, which is a schematic diagram of an interactive broadcasting process 30 according to an embodiment of the present invention. As shown in FIG. 3, the interactive broadcasting process 30, which may be realized in the service providing system 10, includes the following steps:

Step 300: Start.

Step 302: The broadcasting station 112 emits radio signals carrying a broadcast program via the air interface I1.

Step 304: The broadcast service receiving module 130 receives the broadcast program via the air interface I1 and a command for triggering a service introduced in the broadcast program.

Step 306: The broadcast service receiving module 130 sends a request related to the service to the service management device 120 via the network-based interface 12.

Step 308: The service management device 120 provides the service for the broadcast service receiving module 130 according to the received request via the network-based interface 12.

Step 310: End.

According to the interactive broadcasting process 30, the service may be provided for the user 150 of the broadcasting system 110 via the service management device 120 and the broadcast service receiving module 130. In Step 302, the broadcasting station 112 of the broadcasting system 110 delivers the broadcast program and emits the radio signals carrying the broadcast program to the broadcast receiver 132 via the air interface I1. The radio signals may be transmitted by using any audio broadcasting technologies such as amplitude modulation (AM), frequency modulation (FM) and digital audio broadcasting (DAB). In a traditional broadcasting system such as the AM and FM, only analog audio signals are transmitted. In an advanced broadcasting system such as the DAB and FM implemented with the radio data system (RDS), data other than audio signals may also be included in radio signals to be transmitted. As a result, the service ID may be carried with the radio signals related to the broadcast program when the broadcasting system 110 is an advanced broadcasting system. Please note that, according to the DAB or RDS technology, the channel may only transmit small amount of data with the audio signals; hence the service ID without detailed content of the service is preferable to be transmitted in the advanced broadcasting system.

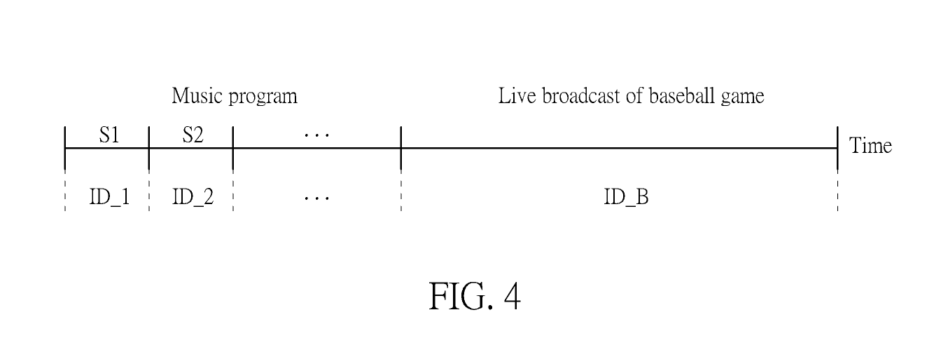

If a service is introduced in the broadcast program, a service ID corresponding to the service may be included in the broadcast program. More specifically, a service ID may be corresponding to a section of the broadcast program or the entire broadcast program, which may correspond to any time period specified by the provider of the broadcast program. Please refer to FIG. 4, which is a schematic diagram of the service ID corresponding to the service included in the broadcast program. As shown in FIG. 4, in a music program, the service may be a download procedure of the title, lyrics, melody or other information related to a song, the service ID may be transmitted at the time interval when the broadcasting station 112 plays the song. For example, at the section when a song S1 is played, a service ID ID_{—}1 is transmitted to the broadcast service receiving module 130, where the service ID ID_{—}1 corresponds to the service of downloading the information related to the song S1. At the section when a song S2 is played, a service ID ID_{—}2 is transmitted, where the service ID ID_{—}2 corresponds to the service of downloading the information related to the song S2. In a live broadcast of a baseball game, a service ID ID_B is transmitted to the broadcast service receiving module 130, where the service ID ID_B may correspond to the service of giving a complimentary ticket for a major league baseball (MLB) game.

In Step 304, the broadcast service receiving module 130 receives the broadcast program via the air interface I1 and a command for triggering a service introduced in the broadcast program. When listening to the broadcast program, the user 150 may give a command to the broadcast service receiving module 130 for triggering a service introduced in the broadcast program if the user 150 is interested in the service, e.g. the download service for a song, the complimentary ticket service for a baseball game, etc. In an embodiment, the user interface 134 of the broadcast service receiving module 130 may include a widget utilized for triggering the service, and the command for triggering the service may be completed by a simple operation on the widget (e.g. a one-click operation). As mentioned above, people usually listen to the broadcast program when driving. The user 150 may not be able to perform complicated operations when driving a car, such that it is desirable to use a one-click operation to complete the command for triggering the service in order to achieve the convenience and safety of the driver.

In Step 306, the broadcast service receiving module 130 sends a request related to the service to the service management device 120 via the network-based interface 12. Since the air interface I1 for transmitting radio signals of the broadcast program is always a unidirectional interface, the broadcast service receiving module 130 has to use an interface different from the air interface I1 to send the request related to the service. The network-based interface 12 may be a wired network such as a wide area network (WAN), local area network (LAN) and/or cable. The network-based interface 12 may also be a wireless network such as a wireless fidelity (Wi-Fi) system, Bluetooth system, long-term evolution (LTE) system, worldwide interoperability for microwave access (WiMAX) system, global system for mobile communications (GSM) and/or general packet radio service (GPRS) system. The network-based interface 12 may also be a combination of different types of networks, which is not limited herein.

In the advanced broadcasting systems, the service ID may be included in the broadcast program to be transmitted, so that the request sending module 136 of the broadcast service receiving module 130 may send the request corresponding to the service ID to the service management device 120, in order to indicate which service the user 150 asks for. For example, if a service ID indicates that the service is a lucky draw and the command for triggering the service is received when the service ID indicating the lucky draw is transmitted, the request sending module 136 may send a request for the lucky draw to the service management device 120, in order to obtain the qualification for the lucky draw.

In the traditional broadcasting systems, however, the service ID is not available to the broadcast service receiving module 130 since data or information other than audio signals cannot be transmitted. In such a condition, the broadcast service receiving module 130 may record a time stamp corresponding to a time when the command for triggering the service is received and record information related to a channel playing the broadcast program and a location of the broadcast service receiving module 130 when the command is received. The broadcast service receiving module 130 may find out a service requested by the user according to the time the user 150 gives the command, the channel the user 150 listens to and the location of the user 150.

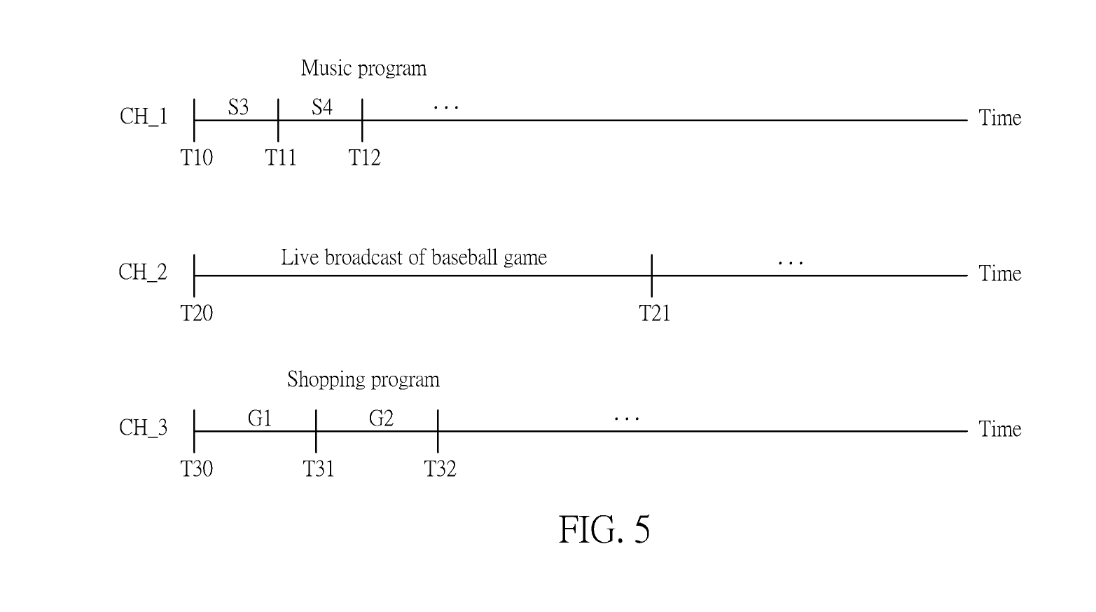

Please refer to FIG. 5, which is a schematic diagram of the time stamp and channel corresponding to the service according to an embodiment of the present invention. As shown in FIG. 5, in the location of the broadcast service receiving module 130, there are three channels CH_{—}1-CH_{—}3. The channel CH_{—}1 plays a music program, and the corresponding service may be a download procedure of the title, lyrics, melody or other information related to a song. A song S3 is played in a section between the time T10 and T11, and a song S4 is played in a section between the time T11 and T12. If the time stamp indicates that the command for triggering the service is received within the time interval between the time T10 and T11, the broadcast service receiving module 130 may check the location of the user 150 and find that the user 150 is listening to the channel CH1, in which the song S3 is played. In such a condition, the broadcast service receiving module 130 may send a request to the service management device 120, where the request is related to the service of downloading the information related to the song S3. The channel CH_{—}2 plays a live broadcast of a baseball game, and the corresponding service may be a complimentary ticket for an MLB game. The baseball game is played in a time interval between the time T20 and T21. If the time stamp indicates that the command for triggering the service is received within the time interval between the time T20 and T21, the broadcast service receiving module 130 may check the location of the user 150 and find that the user 150 is listening to the channel CH2, in which the baseball game is played. In such a condition, the broadcast service receiving module 130 may send a request to the service management device 120, where the request is related to the service of giving the complimentary ticket. The channel CH_{—}3 plays a shopping program, and the corresponding service may be a selling of goods. Goods G1 is introduced in a section between the time T30 and T31, and goods G2 is introduced in a section between the time T31 and T32. If the time stamp indicates that the command for triggering the service is received within the time interval between the time T30 and T31, the broadcast service receiving module 130 may check the location of the user 150 and find that the user 150 is listening to the channel CH3, in which the goods G1 is introduced. In such a condition, the broadcast service receiving module 130 may send a request to the service management device 120, where the request is related to the service of the selling of goods G1. As can be seen, the shopping program is feasible in the audio broadcast program according to the above embodiment of the present invention. When listening to the shopping program, the user 150 will no longer need to make a phone call or further access the Internet to purchase the desired goods. Instead, the user may use a one-click operation to complete the purchase, even when she/he is driving a car.

In Step 308, the service management device 120 provides the service for the broadcast service receiving module 130 according to the received request via the network-based interface 12. If the broadcasting system is a traditional broadcasting system such as the AM and traditional FM, the service ID may not be available, such that the service is provided according to the time stamp, the information related to the channel playing the broadcast program and the location of the broadcast service receiving module 130. If the broadcasting system is an advanced broadcasting system such as the DAB and FM implemented with the RDS, the service ID may be available, such that the service is provided according to the service ID received by the broadcast service receiving module 130.

In an embodiment, the service provider may provide more abundant services where a service may include several selecting items for the service content. When the request sending module 136 of the broadcast service receiving module 130 sends the request related to the service, the service providing server 202 of the service management device 120 may send the selecting items to the user service terminal 138 of the broadcast service receiving module 130 via the network-based interface 12 according to the received request. The user interface 134 of the broadcast service receiving module 130 then generates an interface in response to the selecting items, in order to obtain a selection result from the user 150. Finally, the broadcast service receiving module 130 transmits the selection result to the service providing server 202 of the service management device 120, in order to determine the service content.

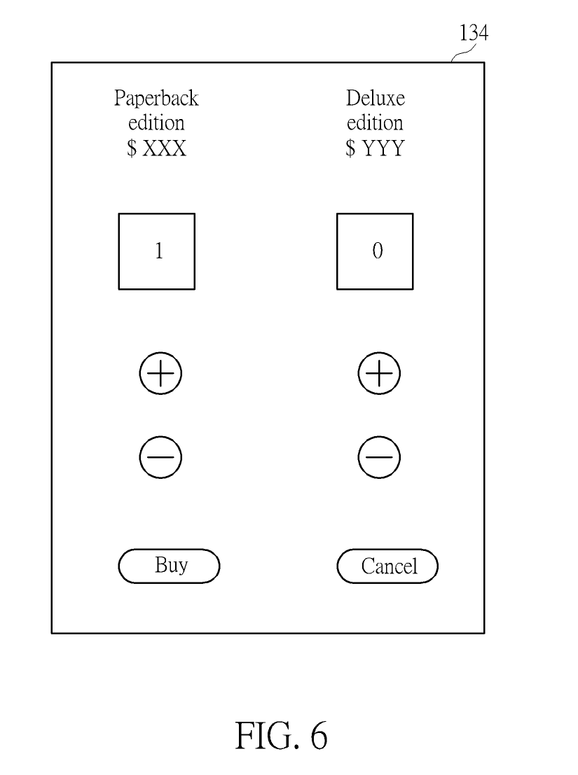

Please refer to FIG. 6, which is a schematic diagram of selecting items displayed in the user interface 134 according to an embodiment of the present invention. As shown in FIG. 6, the broadcast program may introduce a book and the service may be a selling of the book. After the request related to purchase of the book is sent, the user interface 134 displays several simple icons according to the selecting items, where the user 150 may select the number of books and the paperback edition or the deluxe edition. Other information such as the price of the book may also be displayed in the user interface 134, which should not be limited herein.

In an embodiment, a simpler user interface may be provided for the user 150 who is driving a car and may not perform a complicated operation. For example, the user interface 134 may only include one button for inputting the command. The user 150 may click the button once for purchasing the paperback edition and click the button twice for purchasing the deluxe edition. In another embodiment, the user interface 134 of the broadcast service receiving module 130 may deliver the selecting items by voice, and the user 150 may click the button when hearing the desired selecting item. Furthermore, the broadcast service receiving module 130 may also include a voice recognition module, which allows the user 150 to give the command by speaking. As a result, when a driver hears an interesting service introduced in the broadcast program, she/he may easily make a request for the service via the above operations. These operations for receiving the command from the user 150 may be implemented in any manners, which should not be limited herein.

In an embodiment, the broadcasting station 112 may transmit different service ID for different service content. For example, in the broadcast program where a book is introduced, a service ID ID_P corresponding to the paperback edition and a service ID ID_D corresponding to the deluxe edition are both included in the broadcast program and transmitted to the broadcast receiver 132 of the broadcast service receiving module 130. If the user 150 wants to buy the paperback edition, the request sending module will send the request corresponding to the service ID ID_P to the service management device 120; if the user 150 wants to buy the deluxe edition, the request sending module will send the request corresponding to the service ID ID_D to the service management device 120. In another embodiment, there may be only one service ID for the purchase of the book, and the request sending module 136 may use different messages to be corresponding to different commands received by the user 150.

Please note that, the present invention is capable of providing services to an audience of the broadcasting system and allowing the audience to request and receive services introduced in a broadcast program via a simple operation. Those skilled in the art can make modifications and alternations accordingly. For example, the broadcasting system 110 may be any type of audio broadcasting system delivering broadcast programs to houses, cars, or other places with broadcast receivers. In addition, the service management device 120 shown in FIG. 2 is only one of possible embodiments. Other structures or implementations may also be applied to the service management device 120, which is not limited herein. For example, if the broadcasting system 110 is a traditional broadcasting system, the service ID is not required, so that the service ID provider 206 shown in FIG. 2 may be omitted. On the other hand, the service may include, but should not be limited to, a subscription for information interesting to the user 150, a complimentary ticket, a lucky draw, a voting, a purchase, a check-in, and/or other service that may be provided with the delivering of the broadcast program.

In an embodiment, when the user 150 is listening to the broadcast program via the air interface I1, the network-based interface 12 may be unavailable. Therefore, the request sending module 136 cannot immediately send the request to the service management device 120. In such a condition, when receiving the command for triggering the service from the user 150, the broadcast service receiving module 130 may store the information related to the request related to the service in the storage device 140 until the network-based interface 12 becomes available. The request sending module 136 then sends the request to the service management device 120 after the network-based interface 12 becomes available. For the traditional broadcasting system such as the AM and traditional FM, the information related to the request may include the time when the command for triggering the service is received, information related to the channel playing the broadcast program and the location of the broadcast service receiving module 130. Such information should be able to indicate which service the user 150 asks for. For the advanced broadcasting system such as the DAB and FM implemented with the RDS, the information related to the request may include the service ID indicating which service the user 150 asks for. If there are selecting items for the service content, the selection may be performed when the broadcast program is received, and information related to the request for selected service content is stored in the storage device 140 until network-based interface 12 becomes available. In other embodiments, the selection may also be performed after the network-based interface 12 becomes available.

Please note that the service providing system 10 may be implemented in any types of broadcasting systems, wherein the broadcast service receiving module 130 may be implemented in any types of electronic devices having broadcast receiving functions. Such electronic devices may include, but should not be limited to, a radio, desktop, laptop, tablet, mobile phone, and any broadcast receiver in a house or a vehicle, etc. The broadcast service receiving module 130 may be a plug-on device attached to any of the electronic devices to realize the service providing method in a hardware manner. The broadcast service receiving module 130 may also be a computer-readable medium having a program for instructing a process of any of the electronic devices to perform the interactive broadcasting method, in order to realize the service providing method in a software manner. Such a computer-readable medium may include any type of physical medium such as a magnetic medium, optical medium or semiconductor medium. More specific examples of a suitable computer-readable medium may include, but should not be limited to, a magnetic tape, a magnetic floppy diskette, a magnetic hard drive, a memory card, a solid-state drive, a USB flash drive, an optical disc, a random access memory (RAM) including a static random access memory (SRAM), a dynamic random access memory (DRAM) and a magnetic random access memory (MRAM), a read-only memory (ROM) including a programmable read-only memory (PROM), an erasable programmable read-only memory (EPROM), an electrically erasable programmable read-only memory (EEPROM), or other type of memory device.

In the prior art, since the broadcast program and carried information are transmitted in a unidirectional channel, the audience may not return any feedback in response to the received information, which limits the facility of the audio broadcasting systems. It is inconvenient and time consuming for the audience to reply such information by making a phone call or accessing the Internet, especially when the audience is driving a car. In comparison, the present invention provides an interactive broadcasting method for a broadcasting system and a related service providing system capable of providing services to an audience of the broadcasting system and allowing the audience to request and receive services introduced in a broadcast program via a simple operation, so that the safety and convenience of the audience can be enhanced even if the audience is driving a car.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An interactive broadcasting method for a broadcasting system, comprising:
emitting, by a broadcasting station of the broadcasting system, radio signals carrying a broadcast program via an air interface;
receiving, by a broadcast service receiving module corresponding to the broadcasting station, the broadcast program via the air interface;
receiving, by the broadcast service receiving module, a command for triggering a service introduced in the broadcast program;
sending, by the broadcast service receiving module, a request related to the service to a service management device via a network-based interface;
providing, by the service management device, the service for the broadcast service receiving module according to the received request via the network-based interface.

2. The interactive broadcasting method of claim 1, wherein the service comprises a plurality of selecting items, and the interactive broadcasting method further comprises:
providing, by the service management device, the plurality of selecting items according to the received request; and
generating, by the broadcast service receiving module, an interface in response to the plurality of selecting items, in order to obtain a selection result;
transmitting, by the broadcast service receiving module, the selection result to the service management device.

3. The interactive broadcasting method of claim 1, wherein the broadcast service receiving module comprises a widget and receives the command for triggering the service via a simple operation on the widget.

4. The interactive broadcasting method of claim 1, wherein the broadcast program comprises at least one service identifier corresponding to the service.

5. The interactive broadcasting method of claim 4, wherein the at least one service identifier is generated by the service management device and transmitted to the broadcasting station.

6. The interactive broadcasting method of claim 4, wherein the service is provided according to the at least one service identifier received by the broadcast service receiving module.

7. The interactive broadcasting method of claim 1, wherein the broadcast service receiving module records a time stamp corresponding to a time when the command for triggering the service is received, and records information related to a channel playing the broadcast program and a location of the broadcast service receiving module.

8. The interactive broadcasting method of claim 7, wherein the service is provided according to the time stamp, the information related to the channel playing the broadcast program and the location of the broadcast service receiving module.

9. The interactive broadcasting method of claim 1, wherein the air interface is a unidirectional interface and different from the network-based interface.

10. The interactive broadcasting method of claim 1, wherein when the network-based interface is not available, the broadcast service receiving module stores information of the request related to the service when receiving the command for triggering the service until the network-based interface becomes available.

11. The interactive broadcasting method of claim 10, wherein the information of the request related to the service comprises a service identifier corresponding to the service or a time stamp corresponding to a time when the command for triggering the service is received, information related to a channel playing the broadcast program and a location of the broadcast service receiving module.

12. The interactive broadcasting method of claim 1, wherein the service comprises a subscription for information interesting to a user, a complimentary ticket, a lucky draw, a voting, a purchase and/or a check-in.

13. A service providing system, comprising:
a broadcasting system, comprising a broadcasting station, for emitting radio signals carrying a broadcast program via an air interface;
a service management device, communicating with the broadcasting system, for managing services; and
a broadcast service receiving module, comprising:
a broadcast receiver, for receiving the broadcast program via the air interface;
a user interface, for receiving a command for triggering a service introduced in the broadcast program;
a request sending module, coupled to the user interface, for sending a request related to the service to the service management device via a network-based interface; and
a user service terminal, for receiving the service provided by the service management device according to the request via the network-based interface.

14. The service providing system of claim 13, wherein the service comprises a plurality of selecting items, and the service management device provides the plurality of selecting items according to the received request.

15. The service providing system of claim 14, wherein the user interface generates an interface in response to the plurality of selecting items, in order to obtain a selection result, and the request sending module transmits the selection result to the service management device.

16. The service providing system of claim 13, wherein the user interface of the broadcast service receiving module comprises a widget and receives the command for triggering the service via a simple operation on the widget.

17. The service providing system of claim 13, wherein the service management device comprises:
a service providing server, for receiving information related to the service from at least one external service provider, and providing the service to the broadcast service receiving module according to the request related to the service; and
a first storage device, coupled to the service providing server, for storing the information related to the service.

18. The service providing system of claim 13, wherein the broadcast program comprises at least one service identifier corresponding to the service.

19. The service providing system of claim 18, wherein the service management device further comprises:
a service identifier provider, for determining the at least one service identifier corresponding to the service; and
a service management interface, coupled to the service identifier provider, for transmitting the at least one service identifier to the broadcasting system.

20. The service providing system of claim 18, wherein the service is provided according to the at least one service identifier received by the broadcast service receiving module.

21. The service providing system of claim 13, wherein the broadcast service receiving module further records a time stamp corresponding to a time when the command for triggering the service is received, and recording information related to a channel playing the broadcast program and a location of the broadcast service receiving module.

22. The service providing system of claim 21, wherein the service is provided according to the time stamp, the information related to the channel playing the broadcast program and the location of the broadcast service receiving module.

23. The service providing system of claim 13, wherein the air interface is a unidirectional interface and different from the network-based interface.

24. The service providing system of claim 13, wherein when the network-based interface is not available, the broadcast service receiving module further comprises:
a second storage device, for storing information of the request related to the service when the broadcast service receiving module receives the command for triggering the service until the network-based interface becomes available.

25. The service providing system of claim 24, wherein the information of the request related to the service comprises a service identifier corresponding to the service or a time stamp corresponding to a time when the command for triggering the service is received, information related to a channel playing the broadcast program and a location of the broadcast service receiving module.

26. The service providing system of claim 13, wherein the service comprises a subscription for information interesting to the user, a complimentary ticket, a lucky draw, a voting, a purchase and/or a check-in.
